(19) United States
(12) Patent Application Publication
(10) Pub. No.: US 2017/0263426 A1
(43) Pub. Date: Sep. 14, 2017

(54) Dynamic Baseline Adjuster

(71) Applicant: LECO Corporation, St. Joseph, MI (US)

(72) Inventors: Timothy A. Hall, St. Joseph, MI (US); Peter Markel Willis, Benton Harbor, MI (US)

(73) Assignee: LECO Corporation, St. Joseph, MI (US)

(21) Appl. No.: 15/455,033

(22) Filed: Mar. 9, 2017

Related U.S. Application Data
(60) Provisional application No. 62/306,440, filed on Mar. 10, 2016.

(51) Int. Cl. H01J 49/00; H01J 49/40

(52) U.S. Cl. CPC H01J 49/0036; H01J 49/401

(57) ABSTRACT

A method of adjusting a baseline value in data received from a mass spectrometer includes generating a plurality of data signal values with a converter. The method also includes categorizing the plurality of data signal values relative to a plurality of threshold values. The plurality of threshold values include a high value, a mid-high value, a mid-low value, and a low value. The method further includes determining (i) a first quantity of data signal values categorized between the high value and the mid-high values, (ii) a second quantity of data signal values categorized between the mid-high value and the mid-low value, and (iii) a third quantity of data signal values categorized between the mid-low value and the low value. The method also includes generating a table of the first quantity of data signal values, the second quantity of data signal values, and the third quantity of data signal values. The method further includes determining whether to increase, decrease, or maintain the baseline value based on the first quantity, the second quantity, and the third quantity.

### FIELD

The present disclosure relates generally to systems and methods for dynamically adjusting a baseline in a set of data, and more particularly to a system and method for dynamically adjusting a baseline in data received from a mass spectrometer.

### BACKGROUND

This section provides background information related to the present disclosure and is not necessarily prior art.

Mass spectrometry (MS) is an analytical technique for determining the elemental composition of a sample or molecule, or for elucidating the chemical structures of molecules, such as peptides and other chemical compounds. Mass spectrometry generally includes ionizing chemical compounds to generate charged molecules or molecule fragments and then measuring of their mass-to-charge ratios. In a typical MS procedure, a sample loaded onto a mass spectrometer undergoes vaporization and the components of the sample are ionized to form charged particles (ions). The positive ions are typically accelerated by an electric field for computation of the mass-to-charge ratio (m/z) of the particles based on the details of motion of the ions as they move through electromagnetic fields. The ions may be sorted by a mass analyzer according to their mass-to-charge ratio (m/z) and detected by a detector for measuring the value of an indicator quantity and providing data for calculating the abundances of each ion present. The calculated mass of each ion may change or drift during operation of the mass spectrometer, due to various factors.

Mass spectrometers differ from each other primarily in the way in which ions of different mass-to-charge ratios are distinguished from each other. Magnetic sector mass spectrometers separate ions of equal energy by the ions' momentum as they are reflected or dispersed in a magnetic field. Quadrupole mass spectrometers separate ions based upon their rate of acceleration in response to a high frequency radio frequency field in the presence of a direct current field. Jon cyclotrons and ion trap mass spectrometers discriminate ions on the frequency or dimensions of their resonant oscillations in alternating current fields. Time-of-flight mass spectrometers discriminate ions according to their velocity over a fixed distance.

Time-of-flight mass spectrometers (TOF-MS) are widely used in analytical chemistry for identification and quantitative analysis of various compounds and their mixtures. A TOF-MS can be used to determine a mass of an ion by accelerating the ion along a flight path (e.g., using an electric field), measuring a flight time of the ion, and determining the mass of the ion by using a relationship of the time-of-flight as a function of the mass. Sensitivity and resolution of such analysis is an important concern for practical use.

### SUMMARY

This section provides a general summary of the disclosure, and is not a comprehensive disclosure of its full scope or all of its features.

One aspect of the disclosure provides a method of adjusting a baseline value in data received from a mass spectrometer. The method may include generating a plurality of data signal values with a converter. The method may also include categorizing the plurality of data signal values relative to a plurality of threshold values. The plurality of threshold values may include a high value, a mid-high value, a mid-low value, and a low value. The method may further include determining (i) a first quantity of data signal values categorized between the high value and the mid-high values, (ii) a second quantity of data signal values categorized between the mid-high value and the mid-low value, and (iii) a third quantity of data signal values categorized between the mid-low value and the low value. The method may also include generating a table of the first quantity of data signal values, the second quantity of data signal values, and the third quantity of data signal values. The method may further include determining whether to increase, decrease, or maintain the baseline value based on the first quantity, the second quantity, and the third quantity.

Implementations of the disclosure may include one or more of the following features. In some implementations, the plurality of threshold values includes a highest value and a lowest value. The method may further include determining a fourth quantity of data signal values categorized between the highest value and the high value, and determining a fifth quantity of data signal values categorized between the lowest value and the low value. In some implementations, the fourth and fifth quantities correspond to noise in the data. In some implementations, the difference between the highest value and the high value is greater than the difference between the high value and the mid-high value, and the difference between the high value and the mid-high value is greater than the difference between the mid-high value and the mid-low value. In some implementations, determining whether to increase, decrease, or maintain the baseline value includes determining whether to increase, decrease, or maintain the baseline value based on the first quantity, the second quantity, the third quantity, the fourth quantity, and the fifth quantity.

In some implementations, the first and third quantities correspond to acceptable high and low variance, respectively, of the data.

In some implementations, the difference between the high value and the mid-high value is greater than the difference between the mid-high value and the mid-low value.

In some implementations, the table includes a histogram of the first quantity, the second quantity, and the third quantity.

In some implementations, the method also includes instructing a preamplifier to increase, decrease, or maintain the baseline value.

Another aspect of the disclosure provides a method of adjusting a baseline value in data received from a mass spectrometer. The method may include generating a plurality data signal values with a converter. The plurality of data signal values may include one or more high values, one or more low values, and one or more middle values. The method may also include determining a quantity of the high values, a quantity of the low values, and a quantity of the middle values. The method may further include assigning the quantity of high values to a high bin, assigning the quantity of low values to a low bin, and assigning the quantity of middle value to a middle bin. The method may also include generating a histogram from the high bin, the low bin, and the middle bin. The method may further include determining whether to increase, decrease, or maintain the baseline value based on the quantity of high values assigned to the high bin, the quantity of low values assigned to the low bin, and the quantity of middle values assigned to the middle bin.

In some implementations, the plurality of data signal values further includes one or more highest values and one or more lowest values. The method may further include determining a quantity of the highest values and determining a quantity of lowest values. In some implementations, the quantity of highest values and the quantity of lowest values correspond to noise in the data. In some implementations, a size of the high bin is greater than a size of the middle bin.

In some implementations, the method includes instructing a preamplifier to increase, decrease, or maintain the baseline value.

Another aspect of the present disclosure provides a baseline adjuster system for adjusting a baseline value of data received from a converter of a mass spectrometer. The baseline adjuster system may include a signal processing circuit and a decision block analyzer circuit. The signal processing circuit may be configured to determine (i) a first quantity of data signal values falling between a high threshold value and a mid-high threshold value, (ii) a second quantity of data signal values falling between the mid-high threshold value and a mid-low threshold value, and (iii) a third quantity of data signal values falling between a mid-low threshold value and a low threshold value. The decision block analyzer circuit may be configured to (i) generate a table of the first quantity of data signal values, the second quantity of data signal values, and the third quantity of data signal values, and (ii) determine whether to increase, decrease, or maintain the baseline value based on the first quantity, the second quantity, and the third quantity.

In some implementations, the signal processing circuit includes a first generation module that assigns the first quantity to a high bin, a second generation module that assigns the second quantity to an middle bin, and a third generation module that assigns the third quantity to a low bin.

In some implementations, the decision block analyzer circuit includes a bin determination module and a baseline adjustment module. The bin determination module may be configured to determine a largest of the first quantity, the second quantity, and the third quantity. The baseline adjustment module may be configured to adjust the baseline value based on the largest of the first quantity, the second quantity, and the third quantity.

In some implementations, the baseline adjuster system is implemented with a field programmable gate array. The field programmable gate array may utilize a very high speed integrated circuit hardware design language.

In some implementations, the decision block analyzer circuit is configured to determine in real time whether to increase, decrease, or maintain the baseline value.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1 is a schematic view of an exemplary mass spectrometer system according to the principles of the present disclosure.

FIG. 2 is a schematic view of an exemplary data acquisition system according to the principles of the present disclosure.

FIG. 3 is a schematic view of an exemplary data acquisition system according to the principles of the present disclosure.

FIG. 4 is an exemplary plot of amplitude versus samples for data acquired from a mass spectrometer according to the principles of the present disclosure.

FIG. 5 is a functional block diagram of an exemplary data control system according to the principles of the present disclosure.

FIG. 6 is a flowchart illustrating an exemplary control method according to the principles of the present disclosure.

Like reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

In general, a time-of-flight mass spectrometer (TOF-MS) determines a mass M of an ion by accelerating ion(s) along a flight path (e.g., using an electric field), measuring a flight time T of the ion(s), and determining the mass M of the ion(s) by using a relationship of the time-of-flight T as a function of the mass M (e.g., a mass calibration equation). For example, the time-of-flight T of each ion can be determined using the following equation

$$T = \frac{d}{\sqrt{2 U}} \sqrt{\frac{M}{z}} , \qquad ( 1 )$$

where d is a flight path length of the ion, M is a mass of the ion, z is a charge of the ion, and U is an electric potential difference (voltage) used to accelerate the ion. Accelerating ions with a known electric field strength U, results in each ion having the same kinetic energy as any other ion that has the same charge z. Since a velocity of the ion depends on its mass-to-charge ratio (m/z), the time that it subsequently takes for ion to travel along the flight path and reach a detector (i.e., time-of-flight T) can be measured. Heavier ions travel relatively slower and relatively longer flight times T than lighter ions.

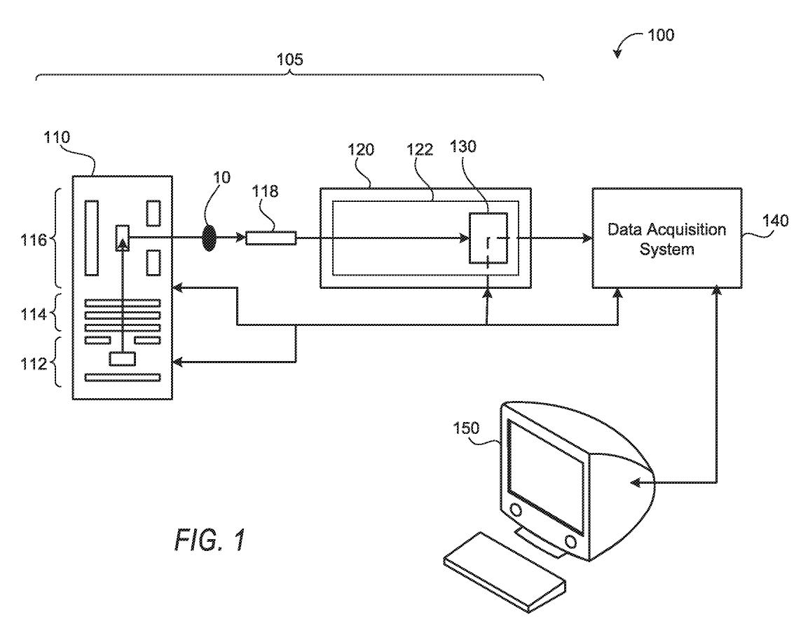

FIG. 1 provides a schematic view an exemplary mass spectrometer system 100 including a time-of-flight mass spectrometer (TOF-MS) 105. The TOF-MS 105 may include one or more ion sources 110 (e.g., an accumulating ion source with transfer ion optics and an orthogonal accelerator) in communication with a TOF analyzer 120 (e.g., a multi-reflecting TOF (M-TOF) analyzer) and a detector 130. In some implementations, the ion source assembly 110 includes an ion source 112 (either pulsed or continuous) (e.g., an accumulating ion source, electrospray ionization (ESI), a liquid chromatograph, a gas chromatograph, a glow discharge source, an inductively coupled plasma source, etc.), delivering ions 10 into transfer ion optics 114 for receipt by an orthogonal accelerator 116, which orthogonally accelerates ions 10 into the TOF analyzer 120. Orthogonal acceleration combined with collisional ion cooling allows separation of the ion production in the ion source 112 and mass analysis. A deflector 118 may be used to direct the ions 10. The ion source assembly 110 accelerates the ions 10 (e.g., packets of ions) through a flight volume 122 (e.g., a flight tube) of the TOF analyzer 120 having a flight path and corresponding flight path length d and into the detector 130. An ion detector or transducer 124 may be disposed at one end of the flight tube 122.

A push pulse of the orthogonal accelerator 116 (e.g., based on a pulse timer) accelerates ions 10 emitted from ion source 112 into a drift region (e.g., multi-reflecting drift region) of the flight tube 116 of the TOF-MS 105. The ions 10 are separated in the drift region based upon their mass to charge ratios (also referred to as mass, M/Z or M). The ions 10 finally reach ion detector 130, which produces an output current in response to ion hits and the current is converted to a voltage using a resistor. The ions 10 with the lowest mass arrive at the detector 130 first, and the ions 10 with the largest mass arrive last.

In some implementations, a single ion hit on detector 130 produces a Gaussian peak with a typical amplitude of 2 mV and a typical full-width-half-height (FWHH) of 2 ns. Ions 10 of similar mass generally group together and hit the detector 130 at approximately the same time, producing proportionally larger responses. The area under the ion peak is proportional to the ion concentration. For the particular example described herein, the maximum output of the detector is 0.5 VDC. A transient represents the period of time between push pulses. It is assumed that all of the ions of interest produced by the push pulse reach the detector 130 by the end of the transient. Ions having the same mass to charge ratio M/Z arrive at the detector 130 with a statistical dispersion due to a number of factors: initial energy dispersion, stability of the ion focusing power supplies, non-uniformity of the focusing fields, etc. The spectrometer's resolution, R, is one expression of the focusing power of the ion optics. The spectrometer's resolution defined by:

$$R = \frac{T}{2 * FWHH} , \qquad ( 2 )$$

where FWHH is the full-width-half-height of the ion peak arriving at time T. Resolution R is characterized over the spectrometer's mass (or spectral) range and typically increases with increasing mass (or time of arrival).

The detector 130 detects ion collisions thereon and generates corresponding indicative ion detection signals in an analog output to a data acquisition system 140 in communication with the detector 130. The data acquisition system 140 communicates one or more outputs to one or more components of the TOF-MS 105 to control operation thereof. The data acquisition system 140 may be in communication (e.g., electrically and/or wirelessly) with an external computing device 150 (e.g., processor, computer, electronic interface, etc.), which may be remote to the TOF-MS 105. A user may control some or all operating parameters of the TOF-MS 105 as well as the data collection and processing procedures followed by data acquisition system 140.

Although the specific examples described herein are directed to calculating and adjusting baselines in a data acquisition system for a time-of-flight mass spectrometer (TOF-MS), the systems and methods for adjusting baselines may have applicability to all other forms of mass spectrometers, and to other systems for analyzing components by detecting ions, which includes, but is not limited to, ion mobility detectors, as well as other types of mass spectrometers, including multi-stage mass spectrometers and glow discharge mass spectrometers, for example.

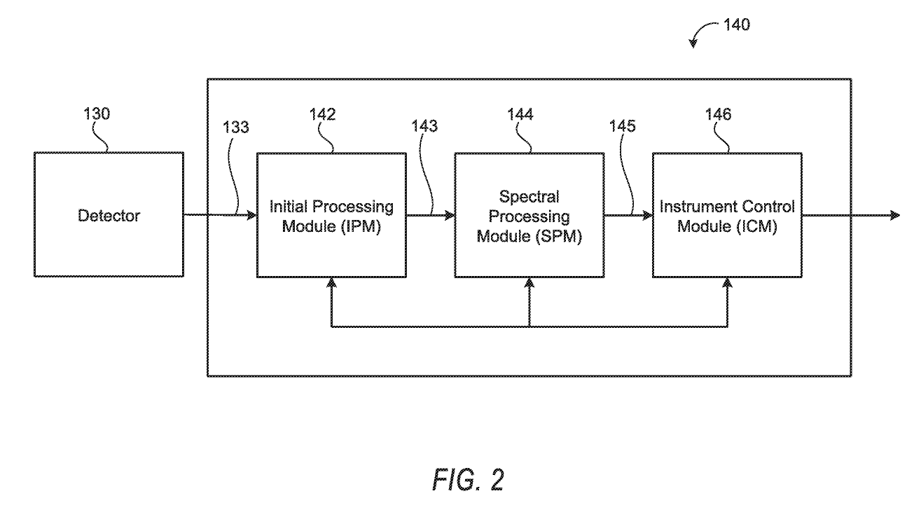

FIG. 2 provides a schematic view of an exemplary data acquisition system 140. The data acquisition system 140 may include two functional modules: an initial processing module (IPM) 142 (also referred to as a transient processing module) that receives an analog input signal 133 from the detector 130 and a spectra processing module (SPM) 144 in communication with and receiving a digital input signal 143 from the IPM 142. The IPM 142 may receive the detector signals 133 to process transients, whereas the SPM 144 may process spectra, which are sums of the transients. In general, the IPM 142 samples the ion detection signals received from ion detector 130, processes the sampled ion detection signals, and supplies processed signals corresponding to transients to the SPM 144. The IPM 142 and the SPM 144 may be implemented in the same circuit components or separately. Optionally, the data acquisition system 140 may include an instrument control module (ICM) 146 configured to receive a digital output 145 from the SPM 144. In some examples, the ICM 146 is in communication with one or more of the other modules, such as the IPM 142 and the SPM 144, and/or the external computing device 150.

The IPM 142 may be capable of sampling the ion detection signals at a rate of at least 1.5 GHz over a full mass range; however, the IPM 142 may be configured to sample at a lower rate and/or over a lesser mass range. For example, the mass range may be selected by an operator and may range from a relatively small range focused on particular masses of interest or include a full mass range. Moreover, the IPM 142 need not be capable of sampling the ion detection signals at a rate of at least 1.5 GHz over a full mass range. In some examples, the IPM 142 continuously samples the ion detection signals over the selected mass range.

As used herein, the phrase “full spectral range” shall mean approximately two orders of magnitude in the ratio of largest M/Z to smallest M/Z. For a mass spectrometer, the spectral range is the mass range. The full spectral/mass range may be different for different sources. For example, the full mass range for a liquid chromatograph may be 50 to 2500 M/Z, whereas the full mass range for a gas chromatograph may be 10 to 1500 M/Z.

The IPM 142 may be configured to have a sensitivity that is sufficient to detect a single ion received within one of over at least 100 transients (e.g., over 1000 transients), and to detect and quantify a number of ions simultaneously striking the detector 130 up to at least 10 simultaneously striking ions (e.g., up to at least 25 simultaneously striking ions, or up to 256 ions).

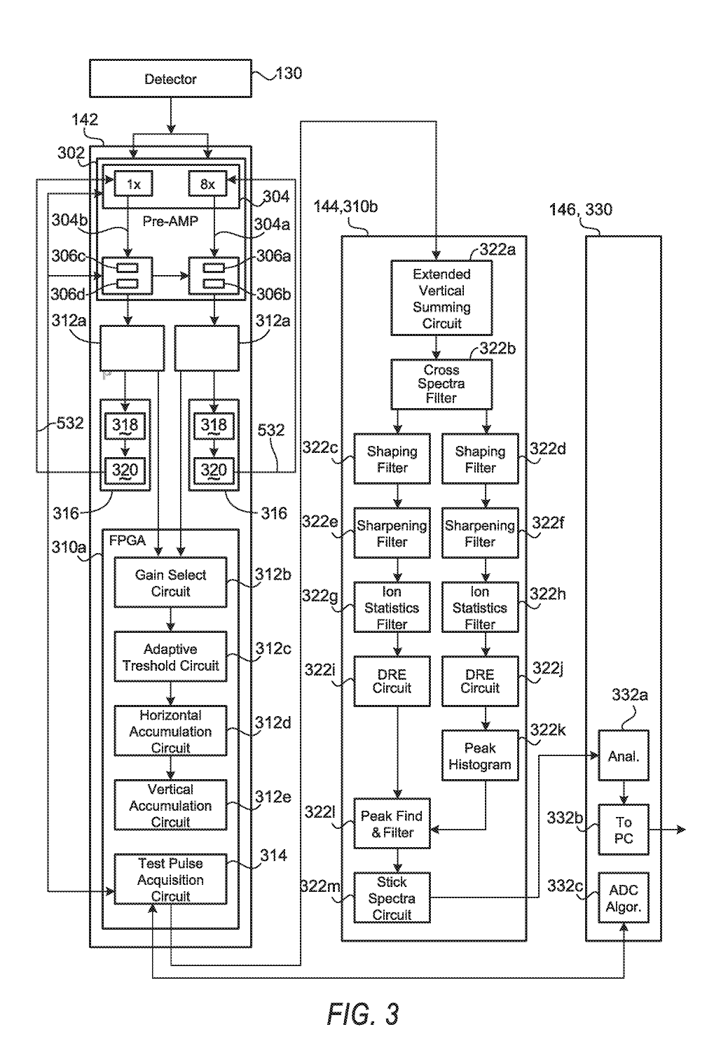

Referring to FIG. 3, a portion of the IPM 142 is implemented with a first field programmable gate array (FPGA) 310a while at least a portion of the SPM 144 is implemented with a second FPGA 310b. Conceivably, the IPM 142 and the SPM 144 may be implemented in a common FPGA or in more than two FPGAs. The ICM 146 may be implemented using an embedded computer 330 or other processing circuitry. The data acquisition system 140 may be implemented entirely within the circuitry of the TOF-MS 105 and/or circuitry external to the TOF-MS 105.

The IPM 142 may include one or more pre-processing circuits 302 that receive an output signal of the detector 130. In the example shown, a pre-amplifier circuit 304 of the IPM 142 receives the output signal of the detector 130 for amplification. The preamplifier 304 may have a first output channel 304a and a second output channel 340b having a lower gain than the first output channel 340a. Moreover, the first output channel 304a may have a gain of, for example, eight times that of the second output channel 304b, which may be a gain of unity. The pre-processing circuit(s) 302 may filter the signals of the first and second output channels 304a, 304b to dissipate out band energy that may be reflected and to provide DC restoration to compensate for the AC coupled detector 130. The filtering may be performed with a DC-400 MHz flat pass band.

The pre-processing circuit(s) 302 may further include first and second high gain channel analog-to-digital converters (high ADCs) 306a, 306b coupled to the first output channel 304a, a high gain channel, and first and second low gain channel ADCs 306c, 306d coupled to the second output channel 304b, a low gain channel. For the two ADCs coupled to a particular channel 304a, 304b, the first ADC 306a, 306c may sample even data points and the second ADC 306b, 306d may sample odd data points. The ADCs 306a-d may allow for onboard offset and gain adjustment and a programmable delay for phase adjustment. The data from the ADCs 306a-d may thus be aligned and weighted. The ADCs 306a-d may both be 8-bit converters and may have a combined 11-bit output. The pre-processing circuit(s) 302 may have a dynamic range for sampling ion detection signals having voltages between about 0.24 mV to about 0.5 V.

In some implementations, non-linearity mismatches between ADCs 306a-d contributes to noise in the data acquisition system 140. The data acquisition system 140 may be configured to accumulate data (e.g., via hardware) before post-processing of the data. In the example shown, the pre-processing circuit(s) 302 (e.g., the ADCs 306a-306d) may include a modulator which toggles between two of the ADCs 306a-d used for a given channel 304a-b. For example, the modulator may toggle between the first and second high gain channel ADCs 306a, 306b and between the first and second low gain channel ADCs 306c, 306d. Alternatively, separate modulators may be used for each pair of ADCs 306a-d. A net effect of switching between two ADCs 306a-d can be nullified by delaying the data path. Where an even number of transients form a spectra, the non-linearity of the two sets of ADCs 306a-d is averaged out.

The outputs of the ADCs 306a-d may be processed to reduce the clock rate but increase the data width. Each ADC 306a-d may have a 16-bit output data bus that updates at 750 MHz. The ADCs 306a-d may thus present data two bytes at a time at 750 MHz. As will be explained in more detail below, each bus may be converted to a 32-bit 375 MHz bus which is fed into first FPGA 310 through one or more divide-and-conquer circuits (DAC) 312a.

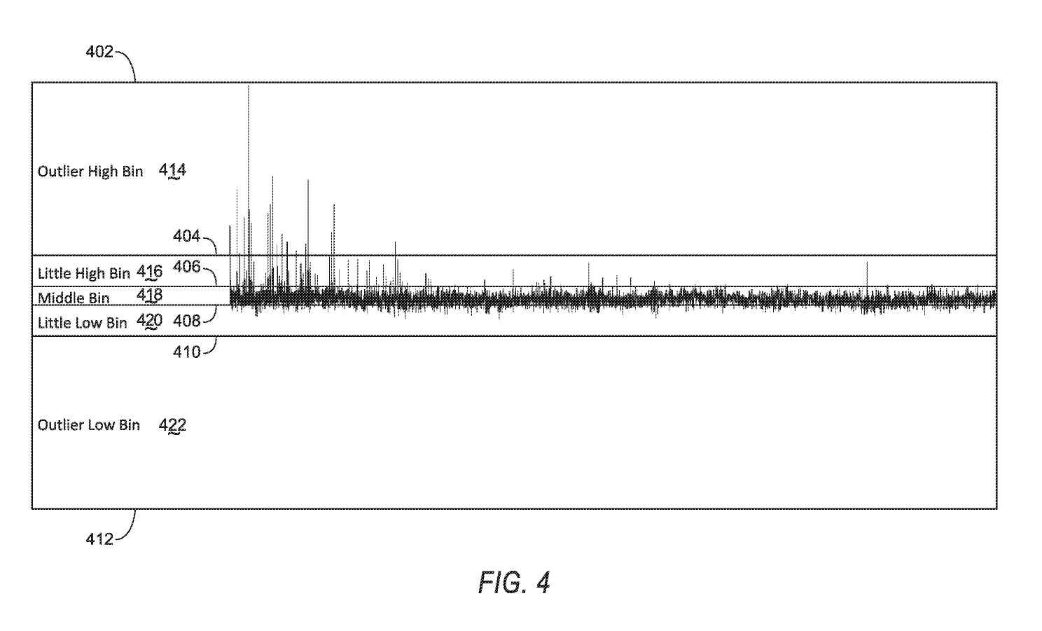

The data processed by the ADCs 306a-d may be categorized relative to a predetermined acceptable baseline value. The acceptable baseline value may represent a calibrated target value for an ion detection event. For example, the acceptable baseline value may represent the time of flight for a particle having a mass-to-charge ratio of 64 (+/−10%). In this regard, the data may be categorized around certain predetermined threshold values. For example, as illustrated in FIG. 4, data (e.g., individual ion detection events) falling between a first or highest value 402 and a second or high value 404 may be categorized as outlier high data points. Outlier high data points may correspond to noise and/or ion spikes in the data acquisition system 140 relative to the baseline value. Data falling between the high value 404 and a third or mid-high value 406 may be categorized as high data points. High data points may correspond to an expected high drift or variance relative to the baseline value. Data falling between the mid-high value 406 and a fourth or mid-low value 408 may be categorized as middle data points. Middle data points may equal to and/or within a predetermined range (e.g., +/−10%) of the baseline value. Data falling between the mid-low value 408 and a fifth or low value 410 may be categorized as low data points. Low data points may correspond to an expected low drift or variance relative to the baseline value. Data falling between the low value 410 and a sixth or lowest value 412 may be categorized as outlier low data points. Outlier low data points may correspond to noise and/or ion spikes in the data acquisition system 140 relative to the baseline value.

The difference between the highest value 402 and the high value 404 may be greater than (i) the difference between the high value 404 and the mid-high value 406, (ii) the difference between the mid-high value 406 and the mid-low value 408, and (iii) the difference between the mid-low value 408 and the low value 410. Similarly, the difference between the lowest value 412 and the low value 410 may be greater than (i) the difference between the mid-low value 408 and the low value 410, (ii) the difference between the mid-high value 406 and the mid-low value 408, and (iii) the difference between the high value 404 and the mid-high value 406. The difference between the mid-low value 408 and the low value 410 may be greater than the difference between the mid-high value 406 and the mid-low value 408. The difference between the high value 404 and the mid-high value 406 may be greater than the difference between the mid-high value 406 and the mid-low value 408.

As illustrated in FIG. 3, the pre-processing circuit(s) 302 may further include a calibration system having one or more baseline adjuster circuit(s) (BAC) 316. As illustrated, the data acquisition system 140 may include a first BAC 316 corresponding to the high ADCs 306a, 306b, and a second BAC 316 corresponding to the low ADCs 306c, 306d. The BAC 316 may be implemented with a field programmable gate array (e.g, first FPGA 310). In particular, the BACs 316 may be implemented with a field programmable gate array described using a very high speed integrated circuit hardware design language (VHDL). The BACs 316 may include a signal processing circuit (SPC) 318 and a decision block analyzer circuit (DBAC) 320. The BAC 316, including the SPC 318 and the DBAC 320, may receive the data from one or more of the ADCs 306a-d through one of the respective DACs 312a. In this regard, the BAC 316 may receive data from the ADCs 306a-d in real time. As will be explained in more detail below, the BAC 316 may categorize the data based on the highest 402, high 404, mid-high 406, mid-low 408, low 410, and lowest 412 values and create a table and/or graph (e.g., a histogram).

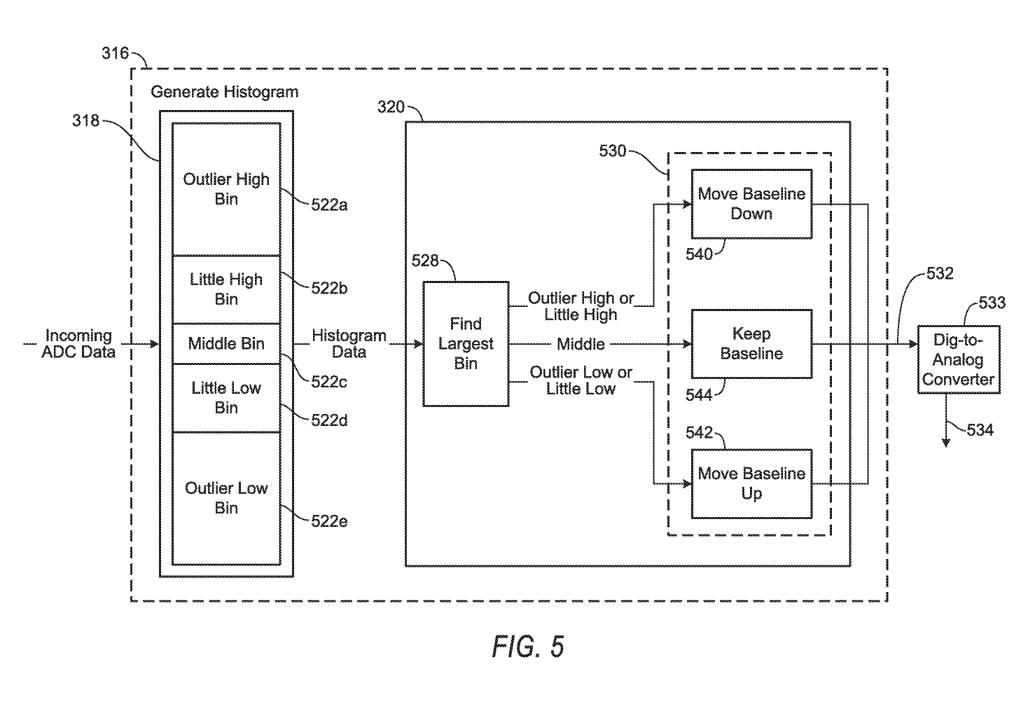

With reference to FIG. 5, an exemplary implementation of the BAC 316 is illustrated. The SPC 318 may include a plurality of generation modules 522a, 522b, . . . 522i, where “i’ is the number of generation modules 522. The generation modules 522 may generate a histogram of the data received from the ADCs 306a-d. In this regard, the generation modules 322 may sum the data (e.g., individual ion detection events) falling between the values 402, 404, 406, 408, 410, 412 and assign the summed data to a bin within the histogram. In some implementations, the SPC 318 includes a first generation module 522a, a second generation module 522b, a third generation module 522c, a fourth generation module 522d, and a fifth generation module 522e.

The first generation module 522a may be referred to herein as an outlier high generation module 522a. In this regard, the outlier high generation module 522a may determine a quantity of highest data values. The highest data values may be the data values that are less than or equal to the highest value 402 and greater than or equal to the high value 404. The outlier high generation module 522a may assign the sum of the highest data values to an outlier high bin 414 (FIG. 4).

The second generation module 522b may be referred to herein as a high generation module 522b. In this regard, the high generation module 522b may determine a quantity of high data values. The high data values may be the data values that are less than or equal to the high value 404 and greater than or equal to the mid-high value 406. The high generation module 522b may assign the sum of the high data values to a high bin 416 (FIG. 4).

The third generation module 522c may be referred to herein as a middle generation module 522c. In this regard, the middle generation module 522c may determine a quantity of middle data values. The middle data values may be the data values that are less than or equal to the mid-high value 406 and greater than or equal to the mid-low value 408. The middle generation module 522c may assign the sum of the middle data values to a middle bin 418 (FIG. 4).

The fourth generation module 522d may be referred to herein as a low generation module 522d. In this regard, the low generation module 522d may determine a quantity of low data values. The low data values may be the data values that are less than or equal to the mid-low value 408 and greater than or equal to the low value 410. The low generation module 522d may assign the sum of the low data values to a low bin 420 (FIG. 4).

The fifth generation module 522e may be referred to herein as an outlier low generation module 522e. In this regard, the outlier low generation module 522e may determine a quantity of lowest data values. The lowest data values may be the data values that are less than or equal to the low value 410 and greater than or equal to the lowest value 412. The outlier low generation module 522e may assign the sum of the lowest data values to an outlier low bin 422 (FIG. 4).

The generation modules 522 may transmit the corresponding quantities of data values (e.g., histogram data) to the DBAC 320. For example, the generation modules 522 may transmit the data relating to each of the bins 414, 416, 418, 420, 422 to the DBAC 320. As illustrated in FIG. 5, the DBAC 320 may include a bin determination module 528 and a baseline adjustment module 530. The DBAC 320 may receive and process the histogram data. In this regard, the bin determination module 528 may determine which of the bins 414, 416, 418, 420, 422 is the largest bin. For example, the bin determination module 528 may determine which of the bins 414, 416, 418, 420, 422 includes the largest quantity of data points (e.g., the largest quantity of individual ion detection events). The baseline adjustment module 530 may determine whether to increase, decrease, or retain the value of the baseline. In this regard, the baseline adjustment module 530 may communicate a baseline adjustment instruction (e.g., signal 532). As will be explained in more detail below, when the outlier high bin 414 or the high bin 416 is the largest bin, the baseline adjustment module 530 may send the signal 532 to instruct the preamplifier 304 to increase the value of the acceptable baseline. Conversely, when the outlier low bin 422 or the low bin 420 is the largest bin, the baseline adjustment module 530 may send the signal 532 to instruct the preamplifier 304 to reduce the value of the acceptable baseline. If the middle bin 418 is the largest bin, the baseline adjustment module 530 may send the signal 532 to retain the value of the acceptable baseline.

In some implementations, the IPM 142 includes a gain select circuit 312b in communication with the DAC 312a, an adaptive threshold circuit 312c in communication with the gain select circuit 312b, a horizontal accumulation circuit 312d in communication with the adaptive threshold circuit 312c, a vertical accumulation circuit 312e in communication with the horizontal accumulation circuit 312d, and a test pulse acquisition and control circuit 314 in communication with the pre-processing circuit 302.

The DACs 312a may divide the data further such that each channel has eight 8-bit busses each running at 187.5 MHz. This data division provides 5.33 ns per data point for initial processing. Each of the eight busses from the high gain channel is paired with a bus from the low gain channel for high/low gain selection. The DACs 312a may communicate with both (e.g., in parallel) the BAC 316 and the gain select circuit 312b. In this regard, the DACs 312a may send a signal to the baseline adjustment module 530. As illustrated in FIG. 5, the baseline adjustment module 530 may communicate with the preamplifier 304 through a digital-to-analog converter 533. In particular, the baseline adjustment module 530 may instruct the preamplifier 304 to increase, decrease, or retain the value of the baseline based on the signal 532 received from the baseline adjustment module 530. In this regard, the digital-to-analog converter 533 may process the signal 532 and communicate a corresponding offset signal 534 to the preamplifier 304. The offset signal 534 may instruct the preamplifier 304 to increase, decrease, or retain the value of the baseline, such that the baseline of each of the output channels 304a-d of the preamplifier 304 remains at a constant value. By adjusting the baseline of the output channels 304a-d in real time, the mass spectrometer 105 can automatically compensate for any drift in the baseline that might otherwise be caused by the age of the detector 130 and/or fluctuations in temperature, voltage, and/or signals, for example.

In some implementations, the SPM 144 includes one or more of an extended vertical summing circuit 322a in communication with the IPM 142 (e.g., the output of the vertical accumulation circuit 312e), a cross-spectra filter 322b in communication with the extended vertical summing circuit 322a, a first shaping filter 322c in communication with a first output of the cross-spectra filter 322b, a second shaping filter 322d in communication with a second output of the cross-spectra filter 322b, a first sharpening filter 322e in communication with the first shaping filter 322c, a second sharpening filter 322f in communication with the second shaping filter 322d, a first ion statistics filter 322g in communication with the first sharpening filter 322e, a second ion statistics filter 322h in communication with the second sharpening filter 322f, a first dynamic range encoded (DRE) circuit 322i in communication with the first ion statistics filter 322g, a second DRE circuit 322j in communication with the second ion statistics filter 322h, a peak histogram circuit 322k in communication with the second DRE circuit 322j, a peak find and peak filter circuit 322l in communication with the peak histogram circuit 322k and the first DRE circuit 322i, and a stick spectra generating circuit 322m in communication with the peak find and peak filter circuit 322l.

The SPM 144 receives the processed signals from IPM 142 and generates spectra at a rate matched to the time response of the separation techniques employed by the spectrometer.

For example, the spectra reporting rate may be at rates up to at least 25 spectra per second (e.g., up to at least 35-500 spectra per second). The spectra reporting rate and the spectral range may both be selected by the operator independent of one another. Because of the capabilities of the system, an operator may select to analyze a full spectral range while also selecting a reporting rate of up to 500 spectra/second. Accordingly, the operator may select narrower spectral ranges and slower reporting rates without one affecting the other. Also, because the data acquisition system 140 may dynamically change the reporting rate as a sample is processed, it supplies the reporting rate used for each spectra with each spectra to the external processor 150. The spectra reporting rate may be changed at predetermined intervals.

The ICM 146 may include one or more of an analysis and spectrum headers circuit 332a in communication with output of the SPM 144, an interface 332b to the external computing device 150 in communication with the analysis and spectrum headers circuit 332a, and an ADC alignment algorithm 332c in communication with the test pulse acquisition and control circuit 314 of the IPM 144.

The ICM 32 may be configured to control the spectrometer 105 by causing it to inject a test pulse at the beginning of each transient that is detected by the data acquisition system 140.

From the test pulse, the data acquisition system 140 may adjust one or more of the phase, offset, or gain of the output channels of the preamplifier 304 in response to the detection signals generated in response to the test pulse.

Other features combinable with this disclosure are provided in U.S. Pat. No. 7,501,621, which is hereby incorporated by reference in its entirety.

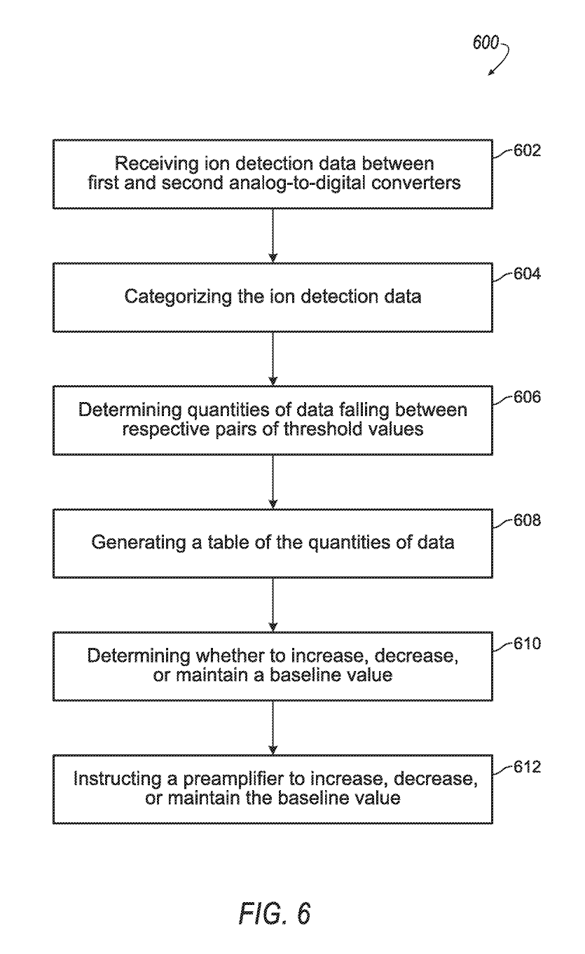

FIG. 6 provides an exemplary arrangement of operations for a method 600 of adjusting a baseline value in data received from a mass spectrometer 105. At 602, the method may include generating a plurality of data signal values with a converter (e.g., ADCs 306a-d). For example, at 602 the method may include generating and/or receiving a plurality of ion detection signals between first and second analog-to-digital converters 306a, 306b. In particular, the first analog-to-digital converter 306a may receive even data points and the second analog-to-digital converter 306b may receive odd data points.

At 604, the method may include categorize the plurality of data signal values relative to a plurality of threshold values. In this regard, the plurality of threshold values may include a highest value, a high value, a mid-high value, a mid-low value, a low value, and/or a lowest value.

At 606, the method may include determining quantities of data signal values falling between respective pairs of the highest, high, mid-high, mid-low, low, and/or lowest threshold values. For example, at 606 the method may include determining a first quantity of data signal values falling between the highest value and the high value, determining a second quantity of data signal values falling between the high value and the mid-high value, determining a third quantity of data signal values falling between the mid-high value and the mid-low value, determining a fourth quantity of data signal values falling between the mid-low value and the low value, and determining a fifth quantity of data signal values falling between the low value and the lowest value.

At 608, the method may include generating a table of the first, second, third, fourth, and/or fifth quantities of data signal values. For example, at 608 the method may include generating a histogram of the first, second, third, fourth, and/or fifth quantities of data signal values. In this regard, the method may include assigning the quantity of highest values to the outlier bin 522a, assigning the quantity of high values to the high bin 522b, assigning the quantity of middle values to the middle bin 522c, assigning the quantity of low values to the low bin 522d, and assigning the quantity of lowest values to the outlier bin 522e.

At 610, the method may include determining whether to increase, decrease, or maintain the baseline value based on the first, second, third, fourth, and/or fifth quantities. In particular, at 610 the method may include determining whether to increase, decrease, or maintain the baseline value based on the quantity of highest values assigned to the outlier bin 522a, the quantity of high values assigned to the high bin 522b, the quantity of middle values assigned to the middle bin 522c, the quantity of low values assigned to the low bin 522d, and the quantity of lowest values assigned to the outlier bin 522e.

If the quantity of highest values is greater than the quantity of high values and/or greater than the value of middle values, at 610 the method may include determining with a baseline adjust module (e.g., a baseline adjust up module 540 of the baseline adjustment module 530 in FIG. 5) to increase the baseline value of the mass spectrometer 105. Similarly, if the quantity of high values is greater than the quantity of middle values, at 610 the method may include determining to increase the baseline value of the mass spectrometer. In particular, if the method determines at 610 that the quantity of highest values and/or the quantity of high values is greater than the quantity of middle values, at 612 the method may include instructing the preamplifier 304 to increase the baseline value.

Conversely, if the quantity of lowest values is greater than the quantity of low values and/or greater than the value of middle values, or if the quantity of low values is greater than the quantity of middle values, at 610 the method may include determining with a baseline adjust module (e.g., a baseline adjust down module 542 of the baseline adjustment module 530 in FIG. 5) to decrease the baseline value of the mass spectrometer 105. In particular, if the method determines at 610 that the quantity of lowest values and/or the quantity of low values is greater than the quantity of middle values, at 612 the method may include instructing the preamplifier 304 to decrease the baseline value.

If the quantity of middle values is greater than the quantities of lowest values, low values, high values, and/or highest values, at 610 the method may include determining with a baseline adjust module (e.g., a baseline maintain module 540 of the baseline adjustment module 530 in FIG. 5) to maintain the baseline value. In particular, if the method determines at 610 that the quantity of middle values is greater than the quantity of lowest values, low values, high values, and/or highest values, at 612 the method may include instructing the preamplifier 304 to maintain the baseline value.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of adjusting a baseline value in data received from a mass spectrometer, the method comprising:
generating a plurality of data signal values with a converter;
categorizing the plurality of data signal values relative to a plurality of threshold values, the plurality of threshold values including a high value, a mid-high value, a mid-low value, and a low value;
determining a first quantity of data signal values categorized between the high value and the mid-high value;
determining a second quantity of data signal values categorized between the mid-high value and the mid-low value;
determining a third quantity of data signal values categorized between the mid-low value and the low value;
generating a table of the first quantity of data signal values, the second quantity of data signal values, and the third quantity of data signal values; and
determining whether to increase, decrease, or maintain the baseline value based on the first quantity, the second quantity, and the third quantity.

2. The method of claim 1, wherein the plurality of threshold values further comprises a highest value and a lowest value, and wherein the method further comprises:
determining a fourth quantity of data signal values categorized between the highest value and the high value; and
determining a fifth quantity of data signal values categorized between the lowest value and the low value.

3. The method of claim 2, wherein the fourth and fifth quantities correspond to noise in the data.

4. The method of claim 2, wherein the difference between the highest value and the high value is greater than the difference between the high value and the mid-high value, and the difference between the high value and the mid-high value is greater than the difference between the mid-high value and the mid-low value.

5. The method of claim 2, wherein determining whether to increase, decrease, or maintain the baseline value includes determining whether to increase, decrease, or maintain the baseline value based on the first quantity, the second quantity, the third quantity, the fourth quantity, and the fifth quantity.

6. The method of claim 1, wherein the first and third quantities correspond to acceptable high and low variance, respectively, of the data.

7. The method of claim 1, wherein the difference between the high value and the mid-high value is greater than the difference between the mid-high value and the mid-low value.

8. The method of claim 1, wherein the table includes a histogram of the first quantity, the second quantity, and the third quantity.

9. The method of claim 1, further comprising instructing a preamplifier to increase, decrease, or maintain the baseline value.

10. A method of adjusting a baseline value in data received from a mass spectrometer, the method comprising:
generating a plurality data signal values with a converter, the plurality of data signal values including one or more high values, one or more low values, and one or more middle values;
determining a quantity of the high values, a quantity of the low values, and a quantity of the middle values;
assigning the quantity of high values to a high bin;
assigning the quantity of low values to a low bin;
assigning the quantity of middle value to a middle bin;
generating a histogram from the high bin, the low bin, and the middle bin; and
determining whether to increase, decrease, or maintain the baseline value based on the quantity of high values assigned to the high bin, the quantity of low values assigned to the low bin, and the quantity of middle values assigned to the middle bin.

11. The method of claim 10, wherein the plurality of data signal values further comprises one or more highest values and one or more lowest values, and wherein the method further comprises:
determining a quantity of the highest values; and
determining a quantity of lowest values.

12. The method of claim 11, wherein the quantity of highest values and the quantity of lowest values correspond to noise in the data.

13. The method of claim 10, wherein a size of the high bin is greater than a size of the middle bin.

14. The method of claim 10, further comprising instructing a preamplifier to increase, decrease, or maintain the baseline value.

15. A baseline adjuster system for adjusting a baseline value of data received from a converter of a mass spectrometer, the baseline adjuster system comprising:
a signal processing circuit configured to determine (i) a first quantity of data signal values falling between a high threshold value and a mid-high threshold value, (ii) a second quantity of data signal values falling between the mid-high threshold value and a mid-low threshold value, and (iii) a third quantity of data signal values falling between a mid-low threshold value and a low threshold value; and
a decision block analyzer circuit configured to (i) generate a table of the first quantity of data signal values, the second quantity of data signal values, and the third quantity of data signal values, and (ii) determine whether to increase, decrease, or maintain the baseline value based on the first quantity, the second quantity, and the third quantity.

16. The system of claim 15, wherein the signal processing circuit includes a first generation module that assigns the first quantity to a high bin, a second generation module that assigns the second quantity to an middle bin, and a third generation module that assigns the third quantity to a low bin.

17. The system of claim 15, wherein the decision block analyzer circuit includes a bin determination module and a baseline adjustment module, the bin determination module configured to determine a largest of the first quantity, the second quantity, and the third quantity, the baseline adjustment module configured to adjust the baseline value based on the largest of the first quantity, the second quantity, and the third quantity.

18. The system of claim 15, wherein the baseline adjuster system is implemented with a field programmable gate array.

19. The system of claim 18, wherein the field programmable gate array utilizes a very high speed integrated circuit hardware design language.

20. The system of claim 15, wherein the decision block analyzer circuit is configured to determine in real time whether to increase, decrease, or maintain the baseline value.
